(19) United States
(12) Patent Application Publication
(10) Pub. No.: US 2016/0301291 A1
(43) Pub. Date: Oct. 13, 2016

(54) CORELESS MOTOR FOR THROTTLE CONTROLLING DEVICE, METHOD FOR MANUFACTURING CORELESS MOTOR FOR THROTTLE CONTROLLING DEVICE, AND THROTTLE CONTROLLING DEVICE

(71) Applicant: NIDEC COPAL CORPORATION, Tokyo (JP)

(72) Inventors: Masaru WADA, Tokyo (JP); Yoshinori HUKASAKU, Tokyo (JP); Hidekuni YOSHIKAWA, Tokyo (JP)

(73) Assignee: Nidec Copal Corporation, Tokyo (JP)

(21) Appl. No.: 15/100,835

(22) PCT Filed: Dec. 2, 2014
(86) PCT No.: PCT/JP2014/081844

§ 371 Date: Jun. 1, 2016

(30) Foreign Application Priority Data
Dec. 3, 2013 (JP) 2013-250567

(51) Int. Cl. H02K 23/58; F02D 11/10; H02K 7/116; H02K 15/03; H02K 3/28; H02K 7/08

(52) U.S. Cl. CPC H02K 23/58; H02K 3/28; H02K 7/08; H02K 7/116; H02K 15/03; F02D 11/10; F02D 2011/101

(57) ABSTRACT

A coreless motor for a throttle controlling device having a cylindrical case, a cylindrical yoke connected non-rotatably to the case in the center side thereof, a magnet secured to an outer peripheral portion of the yoke, a shaft passing through the interior of the yoke and supported rotatably on the case on the outside of the yoke, and a cylindrical coil arranged in a cylinder between the inner peripheral surface of the case and the magnet, and wherein one end side in the axial direction is connected to the shaft, so as to be able to rotate integrally with the shaft. The ring-shaped supporting member having rigidity is secured to the other end side, in relation to the one end side, of the cylindrical coil and is born rotatably by a bearing from the inner peripheral side thereof, and the bearing is provided in a stationary position within the case.

### CROSS-REFERENCE TO RELATED APPLICATIONS

This application is a U.S. National Phase Application under 35 U.S.C. §371 of International Patent Application PCT/JP2014/081844, filed Dec. 2, 2014, which claims priority to Japanese Patent Application No. 2013-250567, filed Dec. 3, 2013. The entire contents of these applications are hereby incorporated by reference.

### FIELD OF TECHNOLOGY

The present invention relates to a coreless motor for a throttle controlling device, a method for manufacturing a coreless motor for a throttle controlling device, and a throttle controlling device, for adjusting the flow rate of air intake into an engine through opening/closing a throttle valve in accordance with a manipulated variable of an accelerator pedal.

### BACKGROUND

A conventional throttle controlling device, as set forth in, for example, Japanese Unexamined Patent Application Publication No. H10-274060, includes a housing (1); a valve bore (10) provided in the housing; a valve unit (21) and a throttle rod (2) that rotates in order to open/close the valve bore; a coreless DC motor (3) disposed in or on the housing (1) so as to be positioned to the side of the valve bore (10); and a transmission mechanism (4) for transmitting, to the throttle rod (2), the rotational force of the coreless DC motor (3).

In such a throttle controlling device, there is the need to reduce the dimension in the valve bore diameter direction, in particular, due to constraints in the space for placement within the engine chamber.

The coreless DC motor (3) has a field magnet (33) that is non-rotatably supported; a motor shaft (34) that is supported so as to rotate within the field magnet (33); and an armature coil (32) with one end side connected to the motor shaft (34), for rotating the surrounding field magnet (33). With such a coreless motor, when compared to a cored motor or a stepping motor, which has a core in a rotating body, the coreless motor is able to produce increased power through a smaller structure with a smaller diameter, and has greater responsiveness, and thus is well suited as a motor for a throttle controlling device.

However, in the conventional coreless DC motor (3) for a throttle controlling device, the structure is one that is held on one side, where only one end side of a cap-shaped armature coil (32) is secured to the motor shaft (34), so there is a danger that the other end side of the armature coil (32) will deform in the radial direction, through thermal deformation or rotational deflection, to come in contact with, for example, a yoke (31) or a field magnet (33) on the inside or the outside thereof in the radial direction. Given this, it is necessary to provide a large gap, or the like, between the inner peripheral surface of the yoke (31) and the armature coil (32), and between the inner peripheral surface of the armature coil (32) and the field magnet (33), despite this causing a reduction in the output power.

### SUMMARY

The present invention was created in contemplation of the conventional situation, described above, and the problem to be solved is that of providing a coreless motor for a throttle controlling device, a method for manufacturing a coreless motor for a throttle controlling device, and a throttle controlling device, that enable high precision control of a throttle valve that is easily manufactured and that has a small structure.

The technical means by which to achieve the object set forth above are a coreless motor for a throttle controlling device having a cylindrical case; a cylindrical yoke that is connected non-rotatably to the case in the center side thereof; a magnet that is secured to an outer peripheral portion of the yoke; a shaft that passes through the inside of the yoke and that is supported rotatably on the case outside of the yoke; and a cylindrical coil that can rotate integrally with the shaft, disposed in a cylindrical shape between the inner peripheral surface of the shaft and the magnet, and having one end side, in the axial direction, connected to the shaft; to enable a throttle valve to be opened/closed through the rotational force of the shaft, wherein:

a ring-shaped supporting member, having rigidity, is secured to the other end side, relative to the one end side of the cylindrical coil, where the ring-shaped supporting member is born rotatably by a bearing portion from the inner peripheral side thereof, and the bearing portion is provided at a stationary position within the case.

Here the stationary position refers to a position that is stationary relative to the cylindrical coil and shaft that undergo rotational motion, where a portion of the case, a portion of the yoke, and the like, are included in this “stationary position.”

Moreover, while there are no particular limitations on the detailed shape of the ring-shaped supporting member, in a particularly preferred form, the ring-shaped supporting member is formed in the shape of a disk, where the outer peripheral surface thereof is secured to the inner peripheral surface of the ring-shaped coil.

Through this structure, the other end side of a cylindrical coil that has one end side thereof connected to a shaft is supported on a bearing portion through a ring-shaped supporting member. As a result, the other end side of the cylindrical coil can be prevented from deforming in the radial direction due to heat or vibration, or the like, during rotation, which, by extension, can prevent the cylindrical coil from coming into contact with the inner peripheral surface of the case, the magnet, or the like, through suppressing rotational deflection of the cylindrical coil, even when the coreless motor for the throttle controlling device is structured so as to be long in the axial direction. Consequently, this is able to prevent damage due to internal contact, thereby enabling an improvement in durability, and making it possible to produce sufficient power for high-precision control of the throttle valve through setting the gaps on the inside and the outside of the cylindrical coil so as to be small. Furthermore, this facilitates superior in manufacturability as well, through simplifying the structures of the supports on both ends of the cylindrical coil.

As preferred means for improving manufacturability, the ring-shaped supporting member is formed from a hard synthetic resin material, and the ring-shaped supporting member is formed so as to be able to rotate smoothly on the outer peripheral surface of the bearing portion.

Moreover, as a preferred form by which to improve the manufacturability of the bearing portion, the case is formed in a closed-bottom cylindrical shape having a bottom on the other end side, and has a through hole, in the center side of the bottom, into which the yoke is inserted, wherein the inner edge portion of the through hole protrudes toward the one end side and acts as the bearing portion.

Moreover, as preferred means the cylindrical coil and the ring-shaped supporting member are adhesively secured; and a through hole for injection of an adhesive agent is provided in the case, connecting the cylindrical coil and the ring-shaped supporting member to a location of the adhesive.

This structure enables bonding of the cylindrical coil and the ring-shaped supporting member, through a through-hole for injecting an adhesive agent, thereby enabling a further improvement in manufacturability.

Moreover, as a preferred method for manufacturing the coreless motor for the throttle controlling device the yoke and the magnet, in the form of a single unit, are inserted into the interior of the cylindrical coil, the ring-shaped supporting member is secured to the other end of the cylindrical coil, and the cylindrical coil, yoke, magnet, and ring-shaped supporting member are inserted into the interior of the case.

This structure enables efficient manufacturing of a coreless motor for a throttle controlling device wherein both ends of the cylindrical coil are supported.

Moreover, in a preferred form of a throttle controlling device, the coreless motor for the throttle controlling device is used as a driving source for opening/closing a throttle valve.

The present invention, structured as described above, enables high-precision control of the throttle valve through a slim structure that is manufactured easily.

### BRIEF DESCRIPTION OF THE DRAWINGS

FIG. 1 is a cross-sectional view of a coreless motor for a throttle controlling device according to the present invention.

FIG. 2 is an assembly perspective diagram of the coreless motor for the throttle controlling device.

FIG. 3 is a perspective diagram illustrating an example of a throttle controlling device that uses the coreless motor for the throttle controlling device.

FIG. 4 is a cross-sectional view of critical portions illustrating another example of a structure for connecting the ring-shaped supporting member and the cylindrical coil.

FIG. 5 is a cross-sectional view illustrating another example of a bearing portion for bearing the ring-shaped supporting member.

### DETAILED DESCRIPTION OF THE INVENTION

Examples according to the present invention will be explained below in detail based on the drawings.

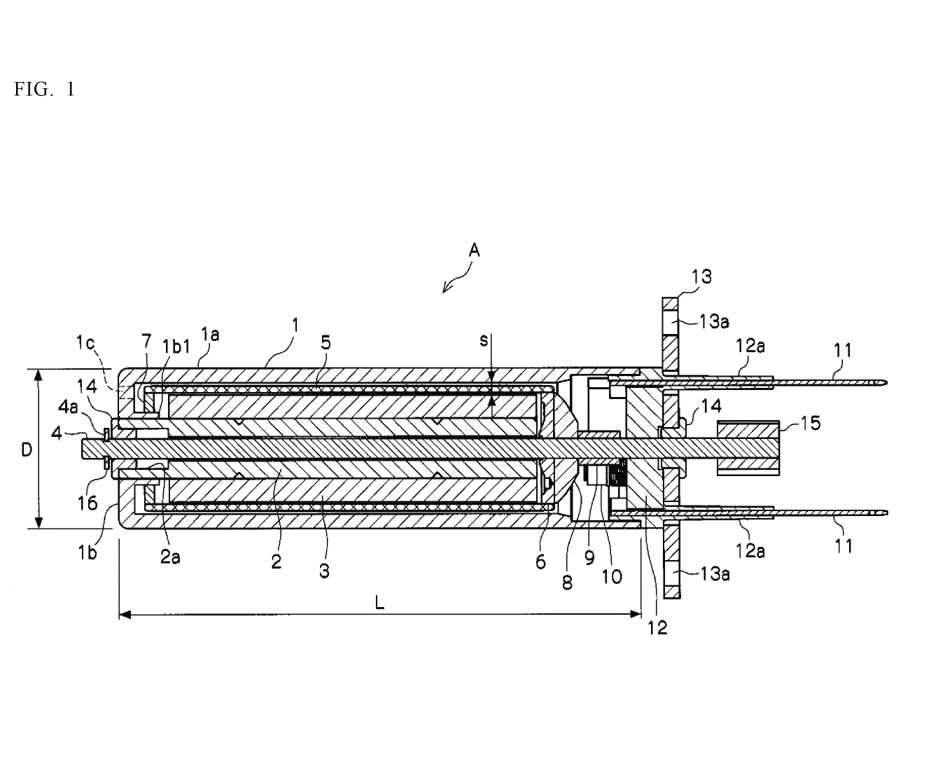

Note that in the explanations below, “front” or “forward” refer to the output side, in the center axial direction, of the shaft 4 (the right side in FIG. 1), and “back” or “rearward” refers to the side that is opposite from the “front” or “forward” (the left side in FIG. 1).

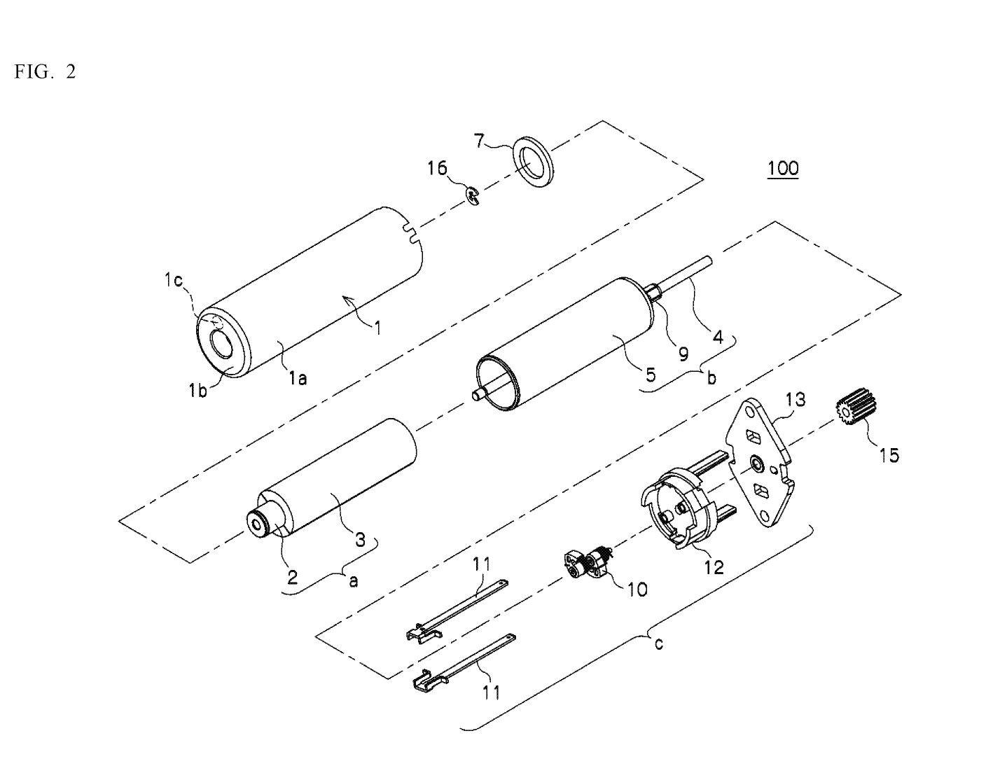

A coreless motor A for a throttle controlling device according to the present example, as illustrated in FIG. 1 and FIG. 2, has a long cylindrical case 1; a long cylindrical yoke 2 that is connected, non-rotatably, to the case 1 on the center side thereof; a magnet 3 that is secured to an outer peripheral portion of the yoke 2; a shaft 4 that is supported rotatably on the case 1 on the outside of the yoke 2, and that passes through the interior of the yoke 2; a cylindrical coil 5 that is disposed cylindrically between the inner peripheral surface of the case 1 and the outer peripheral surface of the magnet 3; a connecting member 6 that connects the cylindrical coil 5 to the shaft 4, on the front end side in the axial direction, so as to enable rotation integrally therewith; a rectifier 9 that is secured on an outer peripheral surface of the shaft 4 and that is connected to the cylindrical coil 5 through an interconnecting member 8; a brush unit 10 that makes sliding contact on the outer peripheral surface of the rectifier 9; a lead terminal 11 for supplying electric power to the brush unit 10; a terminal supporting unit 12 for supporting the brush unit 10 and the lead terminal 11; a bearing flange 13 that is secured to the front side of the terminal supporting unit 12; and a ring-shaped supporting member 7 that is secured to the back end side of the cylindrical coil 5, and is structured so as to open/close a throttle valve through rotation of the shaft 4.

The case 1 includes a long cylindrical cylinder portion 1a that is integrated with a bottom 1b at the position of the back end portion of the cylinder portion 1a, to form an essentially closed-bottom cylinder from a magnetic metal material.

The cylindrical portion 1a has a prescribed clearance relative to the outer peripheral surface of the cylindrical coil 5 that is located therein, and a terminal supporting unit 12, described below, is secured on the front end thereof.

The bottom 1b has a through hole, in the center side thereof, into which the yoke 2 is inserted, where the inner edge portion of the through hole protrudes forward from the inner surface of the bottom 1b, as a bearing portion 1b1 for bearing the ring-shaped supporting member 7.

The bearing portion 1b1 forms a cylinder, and not only is the bearing portion 1b1 born rotatably along the entire periphery of the outer peripheral surface thereof, but the yoke 2 is fitted, non-rotatably, into the inner peripheral surface thereof.

Moreover, the yoke 2 is a long cylindrical member made from a magnetic metal material, where a shaft 4 is inserted therein, with a gap in the radial direction, and the magnet 3 is secured, through securing means such as an adhesive, press-fitting, or the like, on the outer peripheral surface thereof.

A cylindrical recessed portion 2a is provided on the back end side of the yoke 2, where a bearing member 14 is fitted and secured in this recessed portion 2a.

The magnet 3 is formed in a long cylindrical shape, having magnetic poles in mutually opposing radial directions, from an arbitrary permanent magnet material, such as, for example, and alnico magnet or a rare earth magnet.

This magnet 3 is formed so that the back end side (the left end side in FIG. 1) is shorter than the yoke 2. That is, the back end side of the yoke 2 protrudes rearward further than the back end portion of the magnet 3.

The shaft 4, in a state wherein a gap is secured between the shaft 4 and the inner peripheral surface of the yoke 2, is inserted coaxially within the yoke 2, and the front end side protrudes further forward than a bearing flange 13 and the back end side protrudes further rearward than the bottom 1b.

The front end side of this shaft 4 is supported rotatably through a bearing member 14 on the center side of the bearing flange 13, described above, and the back end side of the shaft 4 is supported rotatably through a bearing member 14 on the back end side of the yoke 2. The bearing member 14 may be, for example, a slide bearing, or, conversely, a rolling bearing, such as a ball bearing, or the like, may be used.

An output gear 15 is secured to the side of the shaft 4 further forward from the bearing flange 13. Moreover, a retaining ring 16, which functions as a retainer, is provided on the side of the shaft 4, further back from the bottom 1b. In the figure, reference symbol 4a is a ring-shaped groove, wherein the retaining ring 16 is installed in a ring shape.

Moreover, the cylindrical coil 5 is a coil, structured in a long cylindrical shape, hardened with a synthetic resin, and is positioned in a space between the inner peripheral surface of the case 1 and the outer peripheral surface of the magnet 3.

The front end side of this cylindrical coil 5 is connected to the outer peripheral surface of a shaft 4 through the connecting member 6. The connecting member 6 is formed in a disk-shape, having a through hole therein, from a rigid material, such as a rigid resin, where the shaft 4 is fitted and secured in the through hole.

Moreover, a lead wire, not shown, leads out from the front end side of the cylindrical coil 5, where this lead wire is connected electrically to the rectifier 9 through an interconnecting member 8.

The rectifier 9 is an electrical conductor that is partitioned in the circumferential direction, which functions in cooperation with the brush unit 10 to invert the direction of the current in the cylindrical coil 5 in accordance with the rotation of the shaft 4.

The brush unit 10 is structured from a pair of brushes and a biasing member (for example, a coil spring, a torsion coil spring, a leaf spring), or the like, for biasing the brushes to push them against the outer peripheral surfaces of the rectifier 9, and is supported on the back end face of the terminal supporting unit 12.

Two lead terminals 11 are provided so as to be connected to the pair of brushes that structure the brush unit 10. Each individual lead terminal 11 is supported through passing through the terminal supporting unit 12, to be exposed on the outside.

The terminal supporting unit 12 is a short circular columnar member that fits in the front end portion of the case 1, in the illustrated example, wherein the shaft 4 is inserted rotatably into the center side thereof, and has a lead terminal retaining portion 12a with a narrow cylindrical shape protruding forward, on an outer peripheral side thereof, where the lead terminal 11 is inserted into the lead terminal retaining portion 12a (referencing FIG. 1). The bearing flange 13 is secured integrally with the front side of this terminal supporting unit 12.

The bearing flange 13 is a flanged member that supports the shaft 4 rotatably through a bearing member 14 in the center side thereof, and that has attaching holes 13a in two end sides thereof in the radial direction. The attaching holes 13a are used for securing, to the throttle controlling device, the coreless motor A for the throttle controlling device.

Note that the bearing flange 13 and the terminal supporting unit 12 may be a member that is formed through monolithic molding.

Moreover, the ring-shaped supporting member 7 is formed in a flat disk ring shape with a through hole in the center portion thereof. The outer diameter of this ring-shaped supporting member 7 is set as appropriate so as to fit, through lightly pressing, into the inner peripheral surface of the cylindrical coil 5. Moreover, the inner diameter of the ring-shaped supporting member 7 is set as appropriate so as to enable the ring-shaped supporting member 7 to rotate smoothly on the outer peripheral surface of the bearing portion 1b 1.

Moreover, the material of the ring-shaped supporting member 7 may be a material of greater rigidity than that of the cylindrical coil 5, and may use, for example, a hard synthetic resin material that is relatively lightweight with superior wear resistance. Moreover, the ring-shaped supporting member 7, as illustrated in FIG. 1, is inserted into the cylindrical coil 5, so as to be flush with the back end face of the cylindrical coil 5, and secured by an adhesive agent.

A distinctive method for manufacturing for the coreless motor A for a throttle controlling device, described above, will be explained in detail next.

First, a stator unit a, a rotor unit b, and a terminal unit c are each structured in advance.

The stator unit a has a magnet 3 secured, in a cylindrical shape, to the outer peripheral surface of a yoke 2 (referencing FIG. 2).

The rotor unit b has, for example, a connecting member 6, a cylindrical coil 5, an interconnecting member 8, a rectifier 9, and the like, installed in a ring shape on a shaft 4 (referencing FIG. 1).

Moreover, in the terminal unit c, the brush unit 10 and the lead terminals 11 and 11 are installed on the terminal supporting unit 12, and the bearing flange 13 is installed thereon (referencing FIG. 2).

Note that the sequence with which these units a, b, and c are structured is arbitrary.

The stator unit a is next assembled into the rotor unit b. Explaining in detail, the stator unit a is inserted into the interior of the cylindrical coil 5 of the rotor unit b, and, at essentially the same time, the shaft 4 is inserted into the interior of the yoke 2 of the stator unit a.

Thereafter, the ring-shaped supporting member 7 is installed on the back end side of the inner peripheral surface of the cylindrical coil 5. At this time, after the ring-shaped supporting member 7 is fitted, in a ring shape, together with the yoke 2 that protrudes rearward from the cylindrical coil 5 (referencing FIG. 1), it is moved forward along the outer peripheral surface of the yoke 2, and fitted on the back end inner peripheral surface of the cylindrical coil 5.

Given this, an adhesive agent is coated between the outer peripheral surface of the ring-shaped supporting member 7 and the inner peripheral surface of the cylindrical coil 5, to secure the ring-shaped supporting member 7 so as to not be able to move forward or backward, and so as to not be able to rotate.

Next, the stator unit a and the rotor unit b, in the state wherein the ring-shaped supporting member 7 is installed, as described above, are inserted, from the front end opening side, into the case 1, at which time the bearing portion 1b1 of the case 1 side is inserted between the outer peripheral surface of the back end side part of the yoke 2 and the inner peripheral surface of the ring-shaped supporting member 7 (referencing FIG. 1).

Thereafter, the bearing member 14 is fitted and secured into the recessed portion 2a of the back end side of the yoke 2, on the back end of the shaft 4.

Moreover, the retaining ring 16 is secured in the ring-shaped groove 4a on the back end side of the shaft 4.

Moreover, the terminal unit c is installed in the front end side of the case 1 (referencing FIG. 2). Explaining in detail, a reduced diameter part of the back end side of the outer peripheral surface of the terminal supporting unit 12 is inserted and fitted into a wide diameter part of the front end side of the inner peripheral surface of the case 1, and, at essentially the same time, the front end side of the shaft 4 is inserted loosely in the through hole at the center side of the terminal supporting unit 12.

Moreover, the bearing flange 13 is fitted onto the front side of the terminal supporting unit 12. At this time, the front end side of the shaft 4 is inserted loosely into the through hole of the center side of the bearing flange 13, and the lead terminals 11 are inserted into the respective lead terminal retaining portions 12a of the terminal supporting unit 12.

Additionally, the bearing member 14 wherein the outer peripheral surface is fitted into a through hole on the center side of the bearing flange 13 is installed in a ring shape and pressed onto the front end side of the shaft 4.

Furthermore, a gear 15 is installed in a ring shape and secured on the front end side of the shaft 4, which protrudes further forward.

In the coreless motor A for a throttle controlling device, structured as described above, when the rotor unit b and the ring-shaped supporting member 7 are rotated through the application of a current over the lead terminals 11 and 11, the ring-shaped supporting member 7 rotates smoothly while the inner peripheral surface thereof makes sliding contact with the outer peripheral surface of the bearing portion 1b1.

Because of this, the deformation of the cylindrical coil 5 in the radial direction due to heating effects and due to rotation are suppressed by the ring-shaped supporting member 7, and, by extension, rotational deflection of the cylindrical coil 5 is suppressed, even when the coreless motor A for the throttle controlling device has a slim shape that is long in the axial direction, as shown in the figure, making it possible to prevent contact of the cylindrical coil 5 with the inner peripheral surface of the case 1 and with the magnet 3, and so forth. Moreover, the gap between the inner peripheral surface of the case 1 and the cylindrical coil 5, and the gap between the inner peripheral surface of the cylindrical coil 5 and the magnet, can be set to be small, making it possible to increase the power effectively.

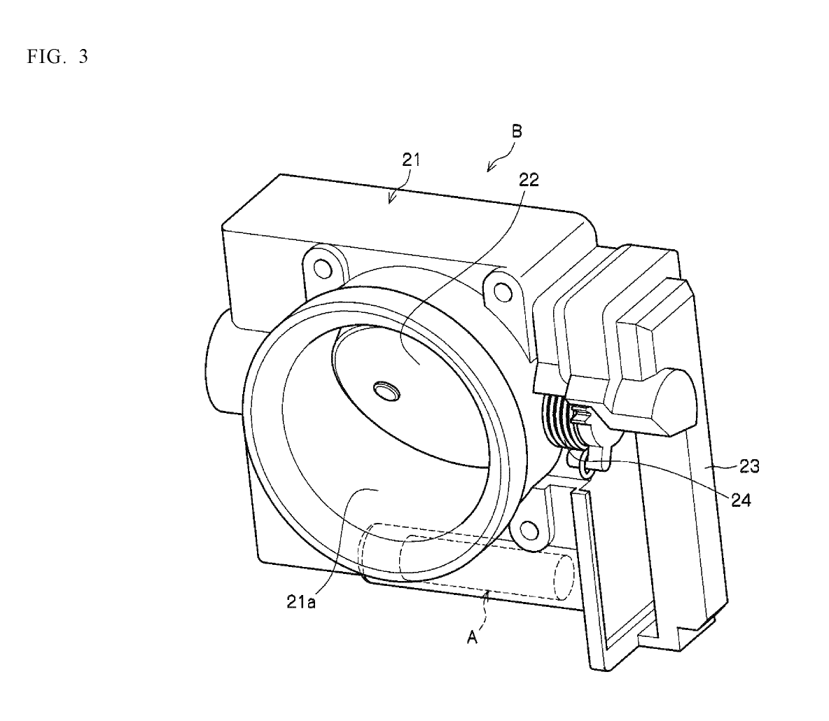

For example, in the example illustrated in FIG. 1, the radial direction dimension s between the inner peripheral surface of the case 1 and the outer peripheral surface of the magnet 3 is about 1 mm, the diameter D of the case 1 is about 16 mm, and the total length L of the case 1 is about 56 mm. That is, a slim shape is used wherein the total length L of the case 1 is between about 3 and 4 times the diameter D of the case 1, enabling high-precision control of the throttle controlling device B, described below (referencing FIG. 3).

The throttle controlling device B illustrated in FIG. 3 comprises: a rectangular block-shaped housing 21 having a valve bore 21a; a throttle valve 22 for rotating to open/close the valve bore 21a; a throttle rod (not shown) that is the rotary shaft of the throttle valve 22; a coreless motor A for a throttle controlling device, described above, that serves as the driving source for opening/closing the throttle valve 22, equipped on the outside of the throttle valve 22; a transmission mechanism 23 for reducing the speed of rotation of the rotor unit b, through meshing of a plurality of gears, and transmitting to the throttle rod; and a return spring 24, for maintaining the minimum opening magnitude of the throttle valve 22 at about a constant.

The coreless motor A for the throttle controlling device is equipped on the outside of the valve bore 21a, with the axial direction of the shaft 4 (the crosswise direction in FIG. 3) essentially parallel to the axial direction of the throttle rod. Moreover, the transmission mechanism 23 is equipped on a side portion on the outside of the valve bore 21a, essentially perpendicular to the axial direction of the throttle rod and the coreless motor A for the throttle controlling device.

Given this throttle controlling device B, the overall shape thereof is that of a slim rectangular block (referencing FIG. 3), enabling easy installation through fitting into a relatively narrow installation space in the engine chamber.

Furthermore, because the throttle valve 22 is opened and closed by the slim coreless motor A for the throttle controlling device, described above, the dimension of the protrusion by the coreless motor A of the throttle controlling device can be made relatively small, with the coreless motor A for the throttle controlling device having a surplus of output torque relative to the rotational load on the throttle valve 22, which, by extension, enables the provision of a throttle controlling device B that is small, with superior responsiveness.

Note that given the method for manufacturing, described above, adhesive bonding is performed using an adhesive agent immediately after fitting of the ring-shaped supporting member 7 on to the cylindrical coil 5; however, as another example, a through hole 1c for injection of an adhesive agent may be provided in the case 1 (referencing the double dotted line in FIG. 1), and the adhesive agent may be injected between the ring-shaped supporting member 7 and the cylindrical coil 5 from the outside of the case 1 through the through hole 1c for injecting the adhesive agent, after the cylindrical coil 5, which is fitted together with the ring-shaped supporting member 7, has been inserted into the case 1.

The through holes 1c for injection of the adhesive agent need only be positioned so as to connect to the location of bonding between the cylindrical coil 5 and the ring-shaped supporting member 7 and, in a preferred example that is illustrated, the through holes 1c for injecting the adhesive agent may be disposed in direct linear contact with the location for bonding the cylindrical coil 5 and the ring-shaped supporting member 7 at the bottom portion 1b.

Because the structure and the manufacturing method described above are able to prevent the adhesive agent from adhering to locations other than the desired locations (for example, the inner edge of the ring-shaped supporting member 7), this enables a further improvement in manufacturability and quality of the coreless motor A for the throttle controlling device.

Note that as another example of a through hole 1c for injecting the adhesive agent, there is a form wherein it is disposed in the cylindrical portion 1a of the case 1.

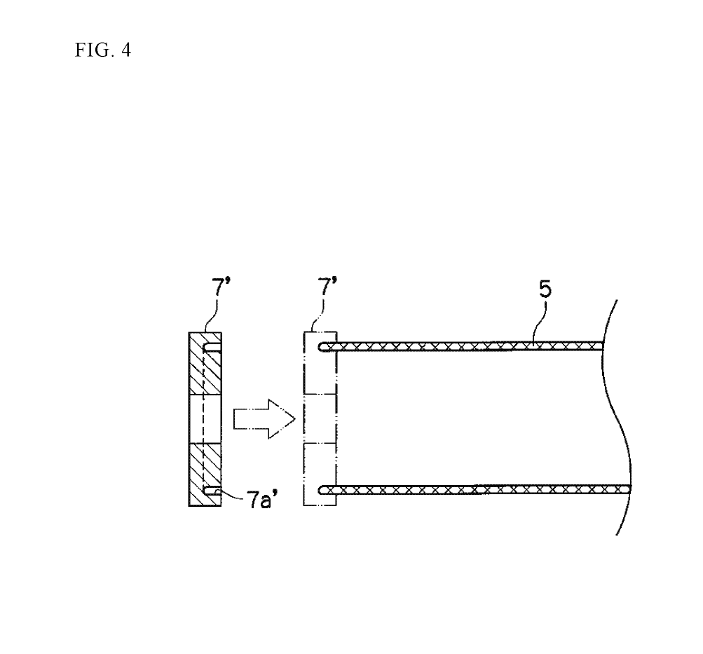

Moreover, while in the forms described above, a disk ring-shaped supporting member 7 is fitted into the inner peripheral surface of the back end side of the cylindrical coil 5, instead, as another example, a ring-shaped supporting member 7′ may be fitted in a corrugated shape together with the cylindrical coil 5, as illustrated in FIG. 4.

The ring-shaped supporting member 7′, in contrast to the ring-shaped supporting member 7, has an outer diameter that is larger than the outer diameter of the cylindrical coil 5, and has, on the front face, which faces the back end of the cylindrical coil 5, a ring-shaped groove 7a′ that is able to fit with the back end of the cylindrical coil 5.

Given this, the ring-shaped supporting member 7′ fits together with the back end portion of the cylindrical coil 5, and is adhesively secured.

When compared to the forms described above, in this alternate example the positioning of the ring-shaped supporting member 7′ in the front/rear direction is easier, enabling a further improvement in manufacturability.

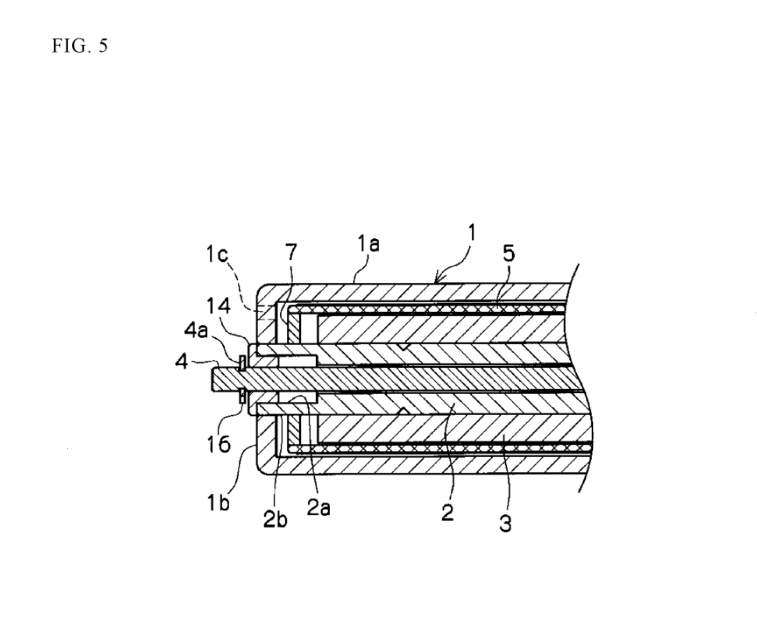

Moreover, while in the form described above a bearing portion 1b1, for bearing the ring-shaped supporting member 7, was formed on the bottom 1b of the case 1, instead the bearing portion 1b1 may be structured to bear the ring-shaped supporting member 7 rotatably from the inner peripheral surface side thereof, in a stationary position within the case 1, and, as another example, as illustrated in FIG. 5, the inner peripheral surface of the ring-shaped supporting member 7 may be born on the outer peripheral surface of the yoke 2.

Explaining in detail, in this alternate example, the bearing portion 1b1 is excluded from the case 1, and the outer peripheral surface of the back end side of the yoke 2 is used as a bearing portion 2b, where the inner diameter of the ring-shaped supporting member 7 is set so as to make sliding contact with the outer peripheral surface of the bearing portion 2b, so that when the ring-shaped supporting member 7 rotates together with the cylindrical coil 5, the ring-shaped supporting member 7 rotates smoothly, born on the bearing portion 2b of the back end side of the yoke 2.

In this alternate example, the shape of the bottom 1b of the case 1 is simplified, facilitating machining, and, at the time of assembly, the ring-shaped supporting member 7 is installed as a ring on the back end side of the yoke 2, and thus there is the benefit in terms of manufacturing, in particular, of being able to support the ring-shaped supporting member 7 rotatably by merely securing the ring-shaped supporting member 7 on to the back end side of the cylindrical coil 5.

1. A coreless motor for a throttle controlling device comprising:
a cylindrical case;
a cylindrical yoke that is connected non-rotatably to the case in the center side thereof;
a magnet that is secured to an outer peripheral portion of the yoke;
a shaft that passes through the inside of the yoke and that is supported rotatably on the case outside of the yoke; and
a cylindrical coil that can rotate integrally with the shaft, disposed in a cylindrical shape between the inner peripheral surface of the shaft case and the magnet, and having one end side, in the axial direction, connected to the shaft, to enable a throttle valve to be opened/closed through the rotational force of the shaft; and
a ring-shaped supporting member, having rigidity, is secured to the other end side, relative to the one end side of the cylindrical coil, where the ring-shaped supporting member is born rotatably by a bearing from the inner peripheral side thereof, and the bearing is provided at a stationary position within the case.

2. The coreless motor for a throttle controlling device as set forth in claim 1, wherein: the ring-shaped supporting member is formed from a hard synthetic resin material; and the ring-shaped supporting member rotates smoothly on the outer peripheral surface of the bearing.

3. The coreless motor for a throttle controlling device as set forth in claim 1, wherein: the case is formed in a closed-bottom cylindrical shape having a bottom on the other end side, and has a through hole, in the center side of the bottom, into which the yoke is inserted, and
wherein the inner edge portion of the through hole protrudes toward the one end side and acts as the bearing.

4. The coreless motor for a throttle controlling device as set forth in claim 3, wherein: the cylindrical coil and the ring-shaped supporting member are adhesively secured; and a through hole for injection of an adhesive agent is provided in the case, connecting the cylindrical coil and the ring-shaped supporting member to a location of the adhesive.

5. The manufacturing method for a coreless motor for a throttle controlling device as set forth in claim 1, wherein: the yoke and the magnet, in the form of a single unit, are inserted into the interior of the cylindrical coil, the ring-shaped supporting member is secured to the other end of the cylindrical coil, and the cylindrical coil, yoke, magnet, and ring-shaped supporting member are inserted into the interior of the case.

6. A throttle controlling device having, as a driving source for opening/closing the throttle valve, a coreless motor for a throttle controlling device as set forth in claim 1.
